(19) United States
(12) Patent Application Publication
(10) Pub. No.: US 2015/0037619 A1
(43) Pub. Date: Feb. 5, 2015

(54) RECHARGEABLE BATTERY PACK

(71) Applicant: SAMSUNG SDI CO., LTD., Yongin-si (KR)

(72) Inventor: Byung-Kook AHN, Yongin-si (KR)

(73) Assignee: SAMSUNG SDI CO., LTD., Yongin-si (KR)

(21) Appl. No.: 14/229,516

(22) Filed: Mar. 28, 2014

Related U.S. Application Data
(60) Provisional application No. 61/860,174, filed on Jul. 30, 2013.

(51) Int. Cl. H01M 2/34

(52) U.S. Cl. CPC H01M 2/34
USPC 429/7

(57) ABSTRACT

A rechargeable battery pack including a unit battery cell; a frame surrounding perimeter sides of the unit battery cell; a protective circuit module electrically connected to the unit battery cell and supported within the frame; and a pair of case members coupled to the frame and covering respective first and second sides of the unit battery cell, the first and second sides being opposite each other, and the frame includes a circuit installation part at a side of the frame and supporting the protective circuit module.

### CROSS-REFERENCE TO RELATED APPLICATION

This application claims priority to and the benefit of U.S. Provisional Application No. 61/860,174, filed on Jul. 30, 2013 in the U.S. Patent and Trademark Office, the entire content of which is incorporated herein by reference.

### BACKGROUND

1. Field

Aspects of embodiments of the present invention relate to a rechargeable battery pack.

2. Description of the Related Art

A rechargeable battery is a battery that can be repeatedly charged and discharged, unlike a primary battery. A low-capacity rechargeable battery may be used for small portable electronic devices, such as a mobile phone, a tablet computer, a notebook computer, and a camcorder, and a large-capacity rechargeable battery may be used as a power supply for driving a motor, such as for an electric bike, a scooter, an electric vehicle, a hybrid vehicle, a forklift, and the like.

The rechargeable battery may be used in a unit battery cell or a pack state in which a plurality of unit battery cells are electrically connected to each other, such as according to a type of the used device. For example, a rechargeable battery pack may include the plurality of unit battery cells, a protection circuit module (PCM) electrically connecting and protecting the plurality of unit battery cells, and a frame receiving the plurality of unit cells and the PCM.

For example, the rechargeable battery pack used in the tablet computer may be configured to receive the unit battery cell in the frame and to attach the unit battery cell and the frame using a label. In this case, the rechargeable battery pack is used in a state in which strength required according to a drop test is not considered, and in which the rechargeable battery pack is not separated from the tablet computer by a user.

However, it may be desired that the rechargeable battery pack be separated from the tablet computer by the user. In this case, the rechargeable battery pack needs the strength required according to the drop test.

The above information disclosed in this Background section is only for enhancement of understanding of the background of the invention and therefore it may contain information that does not form the prior art that is already known in this country to a person of ordinary skill in the art.

### SUMMARY

According to an aspect of embodiments of the present invention, a rechargeable battery pack, such as a rechargeable battery pack formed of a tablet type, has strength required according to a drop test.

According to an exemplary embodiment of the present invention, a rechargeable battery pack includes: a unit battery cell; a frame surrounding perimeter sides of the unit battery cell; a protective circuit module electrically connected to the unit battery cell and supported within the frame; and a pair of case members coupled to the frame and covering respective first and second sides of the unit battery cell, the first and second sides being opposite each other, and the frame includes a circuit installation part at a side of the frame and supporting the protective circuit module.

In one embodiment, the unit battery cell is a first unit battery cell, and the rechargeable battery pack further includes a second unit battery cell, and the circuit installation part and the protective circuit module are between the first and second unit battery cells.

The unit battery cell may include: an electrode assembly including a positive electrode, a negative electrode, and a separator between the positive electrode and the negative electrode; a pouch accommodating the electrode assembly; and a positive electrode lead tab and a negative electrode lead tab electrically connected to the positive electrode and the negative electrode, respectively, and protruding outside the pouch in a same direction, and the circuit installation part may include one or more first protrusions positioning at least one of the positive or negative electrode lead tabs.

The circuit installation part may have one or more first through-holes, and a case member of the pair of case members may have one or more second through-holes corresponding to the one or more first through-holes, the one or more first through-holes and the one or more second through-holes exposing at least one of the positive or negative electrode lead tabs to an outside of the case member.

The circuit installation part may include at least one second protrusion supporting a side of the protective circuit module.

In one embodiment, the protective circuit module includes a connector, and the frame has an opening exposing the connector to an outside of the frame, and the circuit installation part includes a third protrusion supporting the connector.

The frame may include a synthetic resin material, and the case members may include a metal.

A case member of the pair of case members may include: a plate part having a plate shape and covering a side of the first and second sides of the unit battery cell; an insertion part bent from edges of the plate part; and a plurality of coupling protrusions on the insertion part and coupled to the frame.

The frame may include an insertion groove receiving the insertion part.

In one embodiment, the insertion groove is a first insertion groove at a first side of the frame, and receives the insertion part of the case member of the pair of case members, and the frame further includes a second insertion groove at a second side of the frame opposite the first side and separated from the first insertion groove by a partitioning portion, the second insertion groove receiving an insertion part of the other case member of the pair of case members.

The frame may include a plurality of coupling openings receiving the coupling protrusions to couple the case member to the frame.

The coupling openings may be arranged along a perimeter of the frame.

The insertion part may include a plurality of extension parts extending in a direction away from the plate part, and the coupling protrusions may be on the extension parts.

Extension parts of the plurality of extension parts may extend from an edge of the insertion part and have widths that decrease in the direction away from the plate part.

A coupling protrusion of the plurality of coupling protrusions may have a three-dimensional structure including a pair of side walls, an inclined wall extending between the side walls, and a connecting wall connecting the side walls and the inclined wall.

The connecting wall may be offset from the insertion part, and the inclined wall may be inclined away from the insertion part in a direction toward the plate part.

The frame may have a coupling opening receiving the coupling protrusion, and the connecting wall and the coupling opening have a same width.

The frame may have a coupling opening receiving the coupling protrusion, and the side walls may be inclined at an angle such that a width of the connecting wall is less than a width of the coupling opening.

The side walls and the connecting wall may be separated from the insertion part along a straight cutout line.

The side walls and the connecting wall may be separated from the insertion part along a cutout line having protrusions and depressions.

According to another exemplary embodiment of the present invention, a rechargeable battery pack includes: a unit battery cell formed of a tablet type rechargeable battery; a frame enclosing the unit battery cell; a protective circuit module electrically connected to the unit battery cell and embedded in the frame; and a pair of cases protecting the unit battery cell and the protective circuit module by coupling with both sides of the frame.

The frame may be made of a synthetic resin material, and the case may be made of a metal material.

The two unit battery cells may be arranged to face each other, and the frame may include a circuit installation part where the protective circuit module is installed on one side of a portion at which the two unit battery cells face each other.

The circuit installation part may include a through hole formed at a portion corresponding to a lead tab of the unit battery cell; a position limit protrusion protruded from one side of the through hole to predetermine a position of the lead tab and support the protective circuit module; and a circuit supporting protrusion having a height higher than that of the position limit protrusion on the edge of the circuit installation part and supporting the side of the protective circuit module.

The frame may further include an opening part formed on one side of the circuit installation part so that a connector of the protective circuit module is positioned at the outside of the frame.

The frame may include an insertion groove continuously formed at both sides of the frame so that the outer wall of the case is inserted therein, and a coupling groove penetrated through from the insertion groove into the outside of the frame.

The coupling grooves may be symmetrically disposed to each other in the frame so as to correspond to the pair of cases. The case may include a plate part corresponding to both surfaces of the frame and the unit battery cell; an insertion part bent downwardly in the plate part to thereby insert into the insertion groove; an extension part having a width that becomes narrow downwardly in the insertion part; and a coupling protrusion protruded from the extension part to thereby couple to the coupling groove.

The coupling protrusion may be formed by cutting the one side and press-processing three sides in the extension part. In addition, the coupling protrusion may include a pair of side walls vertically connected with the extension part, an inclined wall that inclinedly connects the side walls in the extension part, and a connecting wall through which the side walls are connected in parallel with the extension part in the inclined wall.

The side walls, the connecting wall, and a cutout line may form a rectangle.

The connecting wall may correspond to a width of the coupling groove, such that the side wall may be closely adhered on an inner side wall of the coupling groove.

The coupling protrusion may be formed by cutting the one side and press-processing three sides in the extension part. In addition, the coupling protrusion may include the pair of side walls inclinedly connected with the extension part, the inclined wall that inclinedly connects the side walls in the extension part, and the connecting wall through which the side walls are connected in parallel with the extension part in the inclined wall.

The side walls, the connecting wall, and the cutout line may be formed in a rectangle, and the connecting wall may have a width narrower than that of the coupling groove, such that the side walls may be spaced apart from the inner side wall of the coupling groove.

The coupling protrusion may be formed by cutting in a protrusions and depressions structure and press-processing three sides in the extension part. In addition, the coupling protrusion may include the pair of side walls inclinedly connected with the extension part, the inclined wall that inclinedly connects the side walls in the extension part, and the connecting wall through which the side walls are connected in parallel with the extension part in the inclined wall, and the cutout line may have the protrusions and depressions structure.

As described above, according to an aspect of embodiments of the present invention, a rechargeable battery pack encloses a tablet type unit battery cell with the frame and has a pair of cases coupled with both sides of the frame to protect the unit battery cell and the protective circuit module embedded therein. That is, according to an aspect of embodiments of the present invention, the rechargeable battery pack may be formed of the tablet type and has the unit battery cell and the protective circuit module embedded in the frame and the case, thereby providing a strength required according to a drop test. In addition, the rechargeable battery pack may be separated from the tablet computer by the user.

### BRIEF DESCRIPTION OF THE DRAWINGS

FIG. 1 is an exploded bottom perspective view of a rechargeable battery pack, according to an exemplary embodiment of the present invention.

FIG. 2 is an exploded perspective view of a unit battery cell of the rechargeable battery pack of FIG. 1, according to an exemplary embodiment of the present invention.

FIG. 3 is a partial exploded perspective view of a frame, a unit battery cell, and a protective circuit module of the rechargeable battery pack of FIG. 1, according to an exemplary embodiment of the present invention.

FIG. 4 is a top view of the frame of the rechargeable battery pack of FIG. 1, according to an exemplary embodiment of the present invention.

FIG. 5 is a side view of the frame of FIG. 4.

FIG. 6 is a partial perspective view showing a state in which a pair of cases is separated from the frame of the rechargeable battery pack of FIG. 1, according to an exemplary embodiment of the present invention.

FIG. 7 is a partial enlarged perspective view of a coupling protrusion of a case of the pair of cases of FIG. 6.

FIG. 8 is a partial side view showing a state in which the pair of cases is coupled with the frame of FIG. 6.

FIG. 9 is a partial cross-sectional view showing a state in which the pair of cases is coupled with the frame of FIG. 6, taken along the line IX-IX in FIG. 8.

FIG. 10 is a partial side view showing a state in which a pair of cases is coupled with a frame of a rechargeable battery pack, according to another exemplary embodiment of the present invention.

FIG. 11 is a partial enlarged perspective view of a coupling protrusion of a case of the pair of cases of FIG. 10.

FIG. 12 is a partial side view showing a state in which a pair of cases is coupled with a frame of a rechargeable battery pack, according to another exemplary embodiment of the present invention.

FIG. 13 is a partial enlarged perspective view of a coupling protrusion of a case of the pair of cases of FIG. 12.

### DESCRIPTION OF REFERENCE NUMERALS INDICATING SOME ELEMENTS IN THE DRAWINGS

| | |
|---|---|
| 10: unit battery cell | 11: electrode assembly |
| 12: pouch | 13: separator |
| 14, 15: positive and negative electrodes | |
| 16, 17: positive and negative | |
| electrode lead tabs | |
| 20: frame | 21: circuit installation part |
| 22: opening part | 24, 25: insertion groove |
| 26, 27: coupling groove | 30: protective circuit module |
| 31: connector | 32: welding part |
| 41, 42: case | 241, 242, 341, 342: case |
| 100, 200, 300: rechargeable battery pack | 121: polymer sheet |
| 122: PET-nylon composite sheet | 123: metal sheet |
| 141, 431, 441: side wall | 142, 432, 442: inclined wall |
| 143, 433, 443: connecting wall | 211, H: through hole |
| 212: position limit protrusion | 213: circuit supporting |
| | protrusion |
| 214, 243: catching protrusion | 411, 421: plate part |
| 412, 422: insertion part | 413, 423: extension part |
| 414, 424, 243, 343: coupling protrusion | L, L3: cutout line |
| W, W1: width | θ: angle of inclination |

### DETAILED DESCRIPTION

The present invention is described more fully herein with reference to the accompanying drawings, in which some exemplary embodiments of the present invention are shown. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

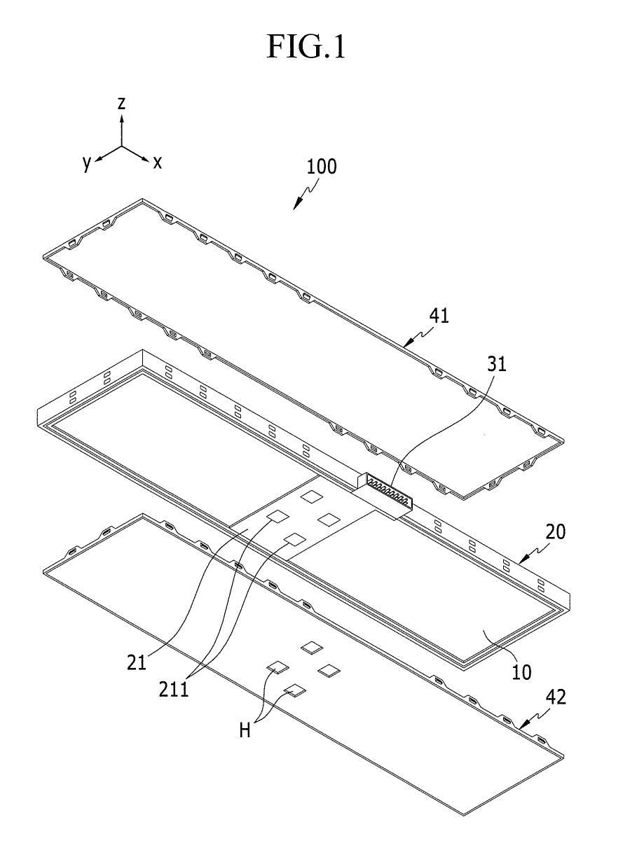

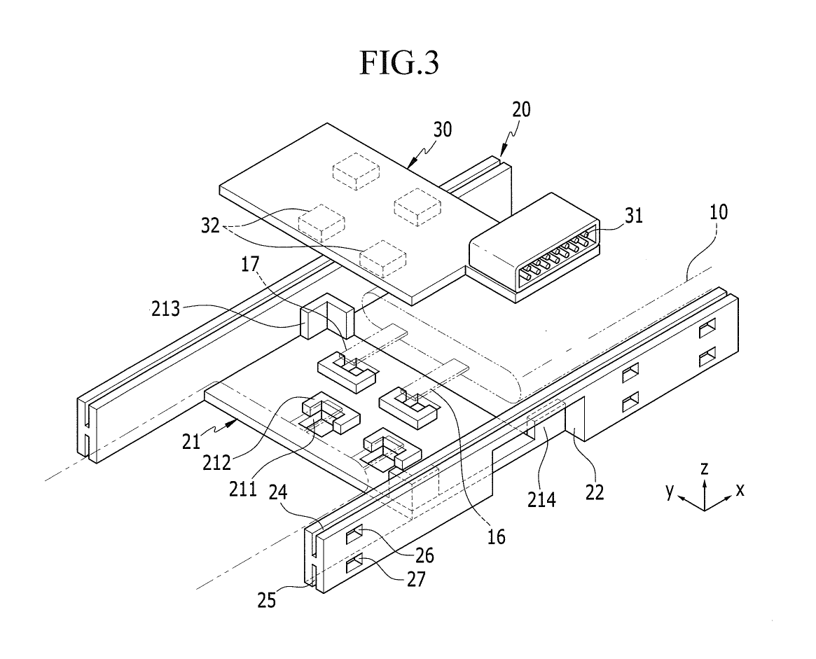

FIG. 1 is an exploded bottom perspective view of a rechargeable battery pack 100 according to an exemplary embodiment of the present invention. Referring to FIG. 1, the rechargeable battery pack 100 according to an exemplary embodiment of the present invention includes a unit battery cell 10 formed of a rechargeable battery, a frame 20 enclosing the unit battery cell 10, a protective circuit module 30 (see FIG. 3), and a pair of cases 41 and 42.

The rechargeable battery pack 100 according to one embodiment of the present invention includes two unit battery cells 10, as shown, but, in other embodiments, may include one or more than two unit battery cells 10. The unit battery cell 10, in one embodiment, is formed of a tablet type rechargeable battery.

The frame 20 encloses the outer side of the thin unit battery cell 10, and the pair of cases 41 and 42 covers wide upper and lower surfaces of the unit battery cell 10. In one embodiment, for example, the frame 20 is made of a synthetic resin material, and the pair of cases 41 and 42 is made of a metal material, such as stainless steel, for example.

The protective circuit module 30 is electrically connected to the unit battery cell 10 to protect the unit battery cells 10. In addition, the unit battery cell 10 and the protective circuit module 30 may be protected from an external impact by the pair of cases 41 and 42 and the frame 20. The protective circuit module 30, in one embodiment, is formed to mount a circuit element on a printed circuit board, such that the unit battery cells 10 may be protected from overcharge, over-discharge, overcurrent and an external short circuit.

In one embodiment, each of the cases 41 and 42 is coupled with an opening formed in a respective one of both surfaces of the frame 20 to protect the unit battery cells 10 and the protective circuit module 30, and may include an insulating tape (not shown) on an inner surface thereof, to thereby improve an electrical insulating property of the unit battery cells 10 and the protective circuit module 30. In addition, the insulating tape protects the unit battery cell 10 from the external impact, thereby further improving stability.

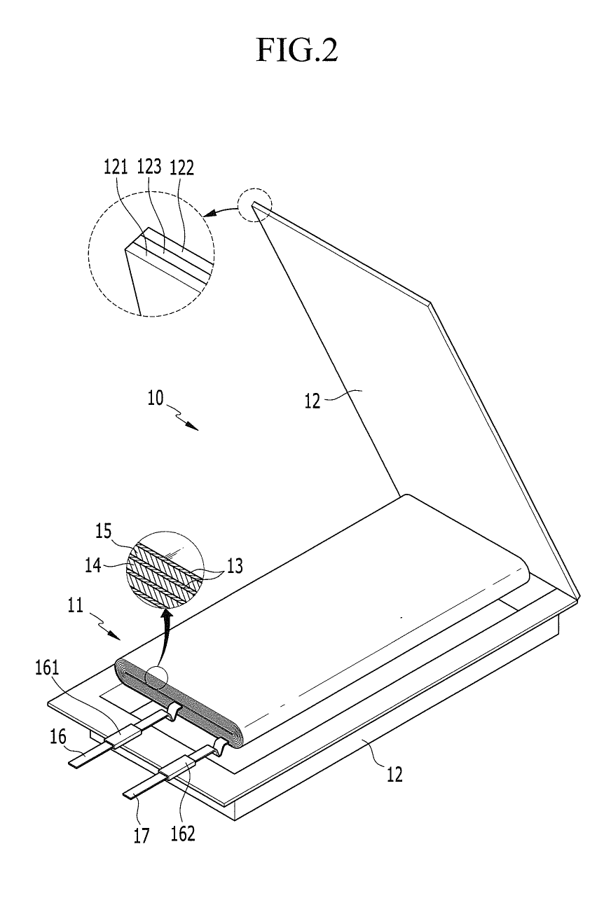

FIG. 2 is an exploded perspective view of the unit battery cell 10, according to an exemplary embodiment of the present invention. Referring to FIG. 2, the unit battery cell 10, in one embodiment, is formed of a pouch type rechargeable battery, and includes an electrode assembly 11 in which charging and discharging are performed, and a pouch 12 having the electrode assembly 11 embedded or received therein.

The electrode assembly 11, in one embodiment, is prepared by disposing and winding a positive electrode 14 and a negative electrode 15 having a separator 13 therebetween, such as to form a tablet type battery cell. In one embodiment, the separator 13 may be formed of a polymer film that transmits lithium-ion.

The positive electrode 14 includes a coating region formed by applying an active material to a current collector of a metal thin film, and an uncoated region formed as a current collector exposed by not applying the active material. In one embodiment, for example, the positive electrode 14 may be formed of an aluminum thin film. A positive electrode lead tab 16 is connected to the uncoated region of the positive electrode 14.

The negative electrode 15 includes a coating region formed by applying an active material which is different from the active material of the positive electrode 14 to a current collector of a metal thin film, and an uncoated region formed as the current collector exposed by not applying the active material. In one embodiment, for example, the negative electrode 15 may be formed of a copper thin film. A negative electrode lead tab 17 is spaced apart from the positive electrode lead tab 16 and is connected to the uncoated region of the negative electrode 15.

The pouch 12, in one embodiment, has one side formed in a concave structure, and the other side formed in a planar structure so as to enclose the outside of the electrode assembly 11, and edges of the concave structure and the planar structure are facing each other in a state in which they are connected to each other and joined to each other by heat-fusion, such that the pouch 12 may receive the electrode assembly 11.

The pouch 12 may be formed in a multi-layered sheet structure. In one embodiment, for example, the pouch 12 may be formed of a polymer sheet 121 forming an inner surface of the pouch 12 and performing the heat-fusion, a polyethylene terephthalate (PET) sheet forming an outer surface of the pouch 12 to protect the electrode assembly 11, and/or a nylon sheet or PET-nylon composite sheet 122.

In one embodiment, the pouch 12 includes a metal sheet 123 provided between the polymer sheet 121 and the PET-nylon composite sheet 122 and provides mechanical strength. In one embodiment, for example, the metal sheet 123 may be formed of an aluminum sheet.

The positive electrode lead tab 16 and the negative electrode lead tab 17, in one embodiment, are drawn out to a same side of the electrode assembly 11. Since the positive electrode lead tab 16 and the negative electrode lead tab 17 are protruded outward of the heat-fused pouch 12, the electrode assembly 11 may be electrically connected to an outer portion of the pouch 12.

Insulating members 161 and 162 may cover the positive and negative electrode lead tabs 16 and 17, respectively, on the pouch 12 to electrically insulate the positive and negative electrode lead tabs 16 and 17 from the pouch 12 to thereby improve the electrical insulating property of the positive and negative electrode lead tabs 16 and 17.

FIG. 3 is a partial exploded perspective view of the frame 20, the unit battery cell 10, and the protective circuit module 30, according to an exemplary embodiment of the present invention. Referring to FIGS. 1 and 3, in the rechargeable battery pack 100, two unit battery cells 10 are arranged to face each other.

The frame 20 encloses the two unit battery cells 10 and includes a circuit installation part 21 provided on one side of a portion at which the two unit battery cells 10 face each other. That is, the circuit installation part 21 is provided at one side of the frame 20 in a height direction of the frame 20 (e.g., a z-axis direction of FIG. 3), and in a central portion of the frame 20 in a length direction of the frame 20 (e.g., an x-axis direction of FIG. 3). The circuit installation part 21 may be provided between the two unit battery cells 10 in the length direction of the frame 20 (e.g., the x-axis direction).

Therefore, the protective circuit module 30 may be installed on the circuit installation part 21 in a state in which it is electrically connected to the two unit battery cells 10. That is, the circuit installation part 21 is joined with the protective circuit module 30 in the height direction of the frame 20 (e.g., the z-axis direction).

In one embodiment, the circuit installation part 21 includes one or more through holes 211, position limit protrusions 212, and circuit supporting protrusions 213. The through holes 211 are formed at the portion corresponding to each of the positive and negative electrode lead tab 16 and 17 of the two unit battery cells 10, and a welding machine (not shown) may approach the through holes 211, such that the positive and negative electrode lead tabs 16 and 17 may be welded to a welding part 32 of the protective circuit module 30.

In one embodiment, the case 42 includes one or more through holes H (see FIG. 1) corresponding to the through holes 211 and the welding part 32, such that the welding machine may approach through the through holes H and 211 in the state in which the frame 20 is assembled with the case 42.

The position limit protrusion 212 is open at a side of the through hole 211 and is protruded in three directions to thereby position (e.g., predetermine a position of) the positive and negative electrode lead tabs 16 and 17 disposed on the open side, and also functions to support the protective circuit module 30. Since the position limit protrusion 212 is protruded from a surface of the circuit installation part 21, the position of the positive and negative electrode lead tabs 16 and 17 may be determined (e.g., predetermined) when the unit battery cell 10 is disposed on the frame 20 in order to weld the positive and negative electrode lead tabs 16 and 17. In addition, the position limit protrusion 212 is protruded from a surface of the circuit installation part 21, thereby preventing or substantially preventing a circuit portion of the protective circuit module 30 from being contacted with the positive and negative electrode lead tabs 16 and 17.

The circuit supporting protrusions 213, in one embodiment, are disposed at edges of the circuit installation part 21 in a diagonal direction (that is, attached to an upper surface of the circuit installation part 21 and an inner side wall of the frame 20) and are protruded to have a height higher than that of the position limit protrusion 212 to support the side surface of the protective circuit module 30. That is, the protective circuit module 30 has a position in a plane (e.g., an x-y plane in FIG. 3) set or determined by the circuit supporting protrusions 213 and a position in a height direction (e.g., the z-axis direction) set or determined by the position limit protrusion 212. Therefore, the protective circuit module 30 may be stably installed to the circuit installation part 21 and supported.

The protective circuit module 30 includes a connector 31 at one side thereof and draws out the connector 31 to the outside of the frame 20, to thereby supply a power. The frame 20 is provided with an opening part 22 formed at one side of the circuit installation part 21. The connector 31 of the protective circuit module 30 may be disposed to the outside of the frame 20 through the opening part 22. A catching protrusion 214 is provided on an inner side of the opening part 22 to support a rear of the connector 31 inserted into the opening part 22, such that the protective circuit module 30 is maintained in a state in which it is stably installed.

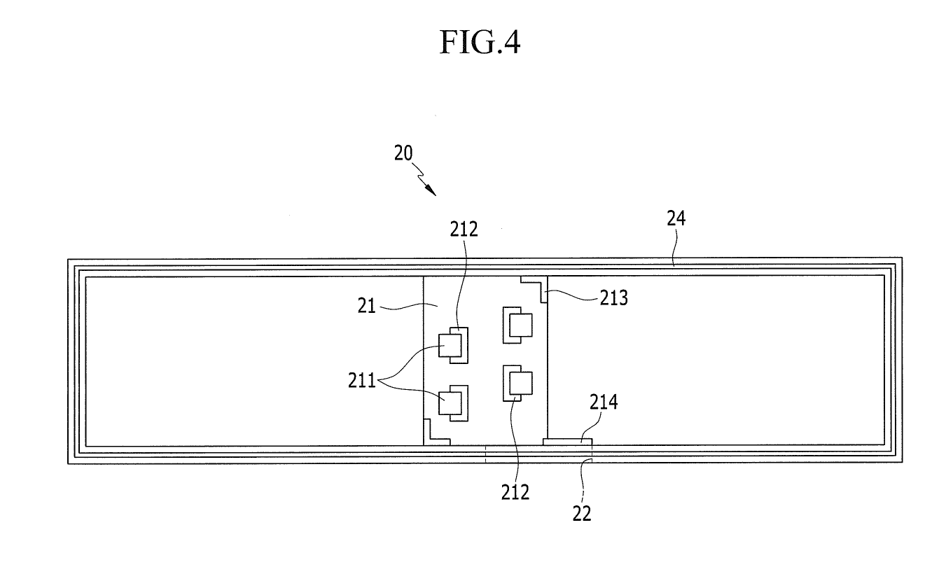

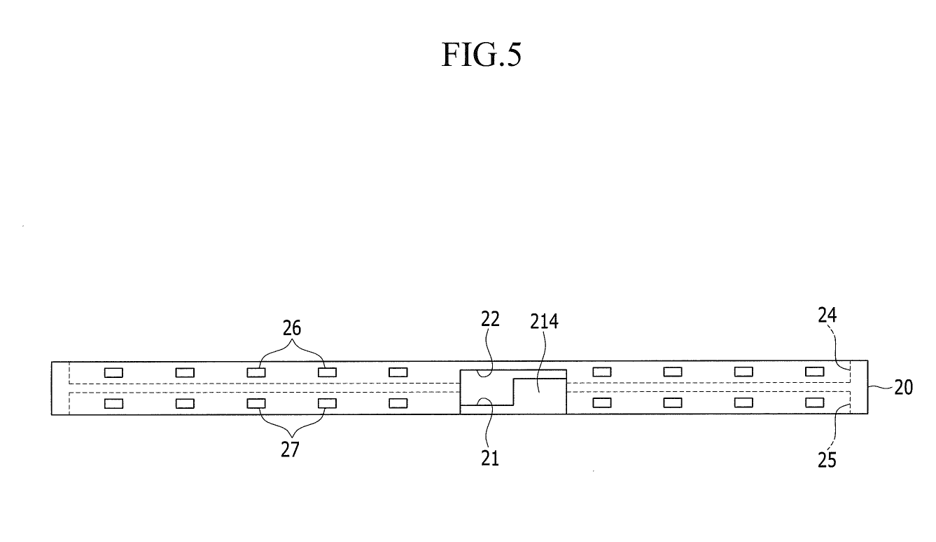

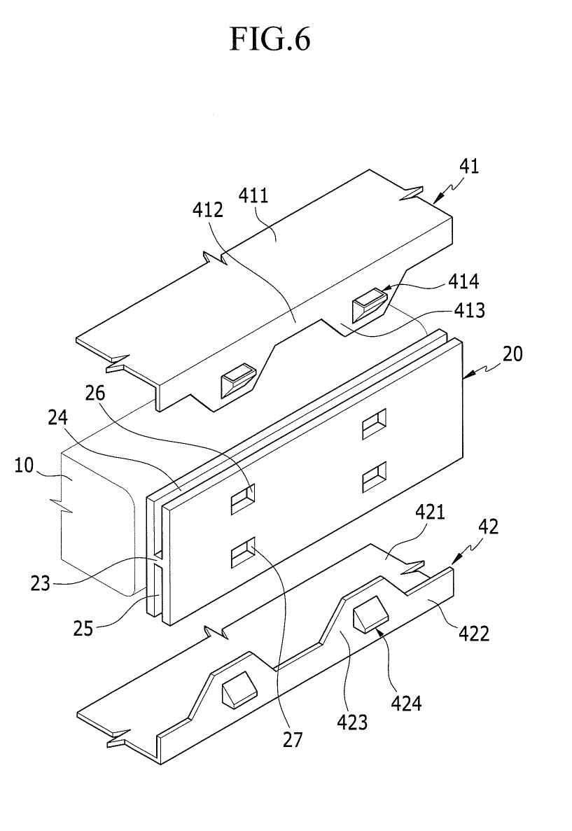

FIG. 4 is a top view of the frame 20; and FIG. 5 is a side view of the frame 20. Referring to FIGS. 4 and 5, the frame 20, according to an exemplary embodiment of the present invention, includes an insertion groove 24 and 25 continuously formed at both sides of the frame such that an outer wall of each of the pair of cases 41 and 42 may be inserted therein, and coupling grooves 26 and 27 penetrated through from the insertion groove 24 and 25 to the outside of the frame 20. In one embodiment, the insertion grooves 24 and 25 are separated from each other by a partitioning portion 23 (see FIG. 6).

The coupling grooves 26 and 27, in one embodiment, are symmetrically disposed to each other in the frame 20 in a height direction (e.g., the z-axis direction) so as to correspond to each of the pair of cases 41 and 42, and the pair of cases 41 and 42 is symmetrically arranged relative to each other corresponding to the coupling grooves 26 and 27.

FIG. 6 is a partial perspective view showing a state in which the pair of cases 41 and 42 is separated from the frame 20. Referring to FIG. 6, in one embodiment, the pair of cases 41 and 42 includes a plate part 411 and 421, an insertion part 412 and 422, an extension part 413 and 423 and a coupling protrusion 414 and 424 such that the pair of cases 41 and 42 is coupled with the frame 20 to receive the unit battery cell 10.

The plate part 411 and 421 is formed in a plate shape to correspond to a respective surface of both surfaces of the unit battery cell 10 and the frame 20 and covers both surfaces of the unit battery cell 10 and the frame 20 in the height direction (e.g., the z-axis direction). The insertion part 412 and 422 is bent at a perpendicular angle to the plate part 411 and 421 and is inserted into a respective one of the insertion grooves 24 and 25 formed in a respective one of both surfaces of the frame 20 in the height direction (e.g., the z-axis direction).

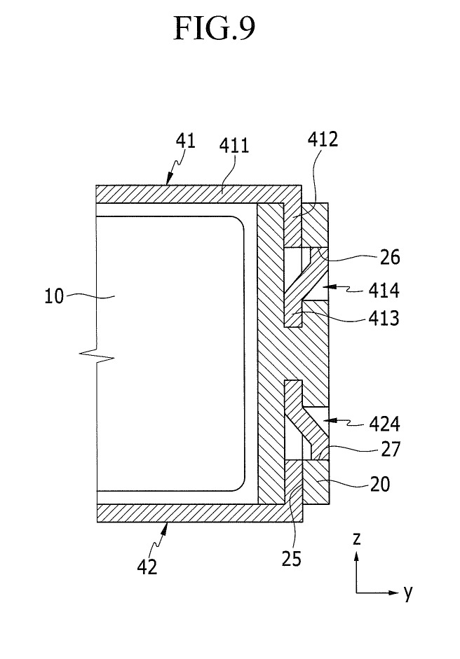

In one embodiment, a plurality of extension parts 413 and 423 is disposed to correspond to a respective one of the insertion grooves 24 and 25 along the insertion part 412 and 422. Further, the plurality of extension parts 413 and 423 are extended to have a width that becomes narrower downwardly in the insertion part 412 and narrower upwardly in the insertion part 422 and may be disposed to be opposite to each of the coupling grooves 26 and 27 in the insertion grooves 24 and 25 (see FIGS. 6 and 9). The coupling protrusions 414 and 424, in one embodiment, are protruded from the extension parts 413 and 423 (e.g., in the y-axis or x-axis direction) and may be connected to each of the coupling grooves 26 and 27 (see FIG. 9).

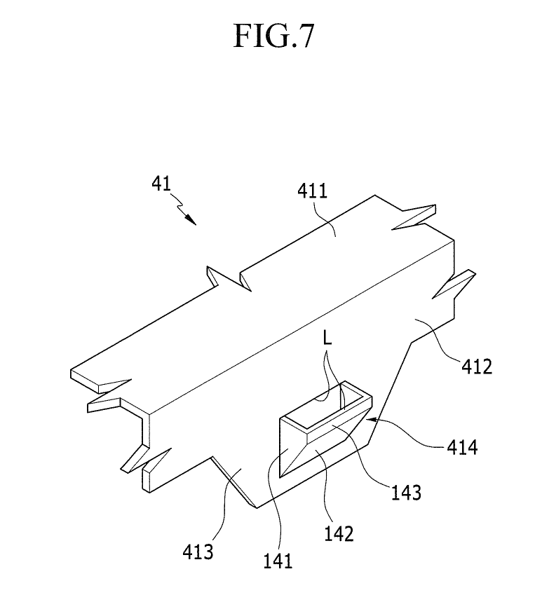

FIG. 7 is a partial enlarged perspective view of one of the coupling protrusions 414 of the case 41. The coupling protrusions 414 and 424 may be formed having a same shape, and for convenience, the coupling protrusion 414 will be described as an example.

Referring to FIG. 7, the coupling protrusion 414 is formed on the extension part 413 such that it is inserted into the insertion groove 24 to couple with the coupling groove 26, and is formed having a three-dimensional structure including a pair of side walls 141, an inclined wall 142, and a connecting wall 143.

The pair of side walls 141 is vertically connected to the extension part 413 in both ends of a cutout line L by cutting one side and press-processing the cutout line L and the remaining three sides in the extension part 413.

The inclined wall 142 is inclinedly connected to the pair of side walls 141 in the opposite side extension part 413 for the cutout line L. Therefore, the inclined wall 142 effectively leads the coupling protrusion 414 inserted into the insertion groove 24.

The connecting wall 143 connects between the side walls 141 and the inclined wall 142 and is disposed in parallel with the extension part 413. In addition, the end of the connecting wall 143 formed in the cutout line L and the end of the side wall 141 are formed to have an opened structure at an opposite side of the inclined wall 142 to couple with the coupling groove 26. Accordingly, the coupling protrusion 414 may maintain a joint force for the frame 20 in the height direction (e.g., the z-axis direction).

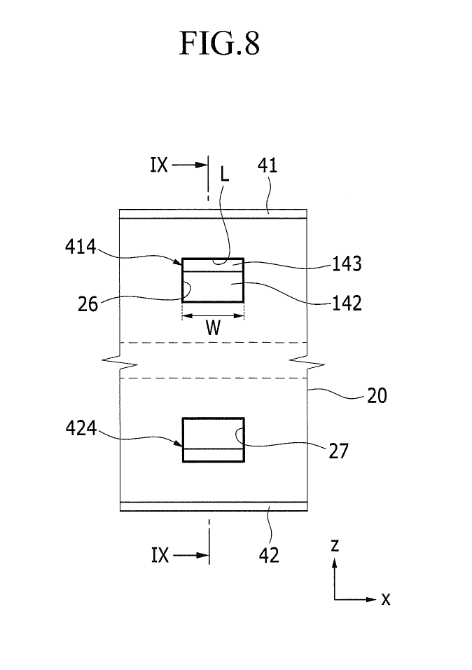

FIG. 8 is a partial side view showing a state in which the pair of cases 41 and 42 is coupled with the frame 20; and FIG. 9 is a partial cross-sectional view showing the state in which the pair of cases 41 and 42 is coupled with the frame 20, taken along the line IX-IX in FIG. 8.

Referring to FIGS. 8 and 9, in one embodiment, the side wall 141, the connecting wall 143, and the cutout line L in the coupling protrusion 414 are formed as a rectangle.

In one embodiment, when the case 41 is coupled to the frame 20, the coupling protrusion 414 is coupled to the coupling groove 26, and the connecting wall 143 has a width corresponding to a width W of the coupling groove 26, such that the side wall 141 provided on both sides of the connecting wall 143 is closely adhered to an inner side wall of the coupling groove 26.

Therefore, the case 41 may be prevented or substantially prevented from moving relative to the frame 20 in a direction (e.g., the x-axis or y-axis direction). In one embodiment, the case 42 is coupled to the frame 20, and the coupling protrusion 424 is coupled to the coupling groove 27 in a same structure and manner as described above with respect to the case 41 and the coupling protrusion 414.

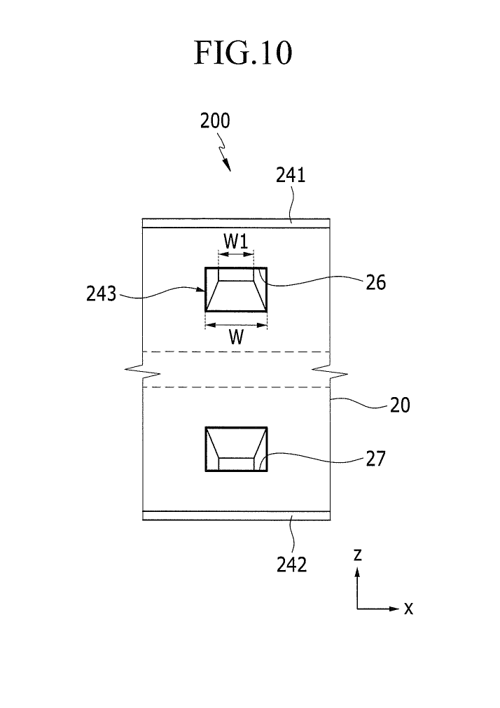

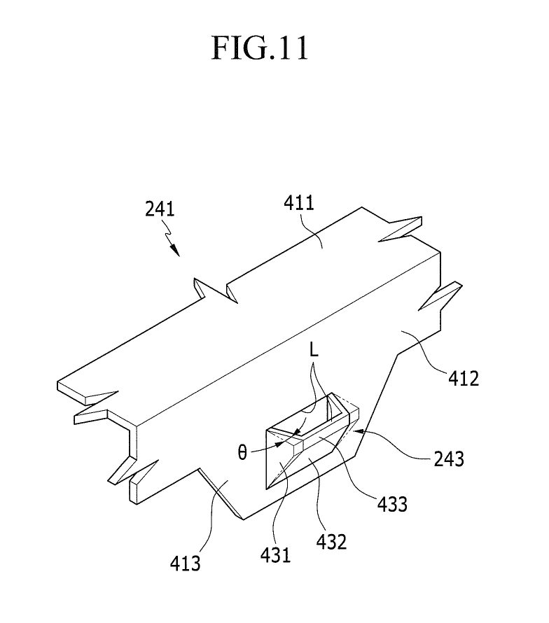

FIG. 10 is a partial side view showing a state in which a pair of cases 241 and 242 is coupled with a frame 20 of a rechargeable battery pack 200, according to another exemplary embodiment of the present invention; and FIG. 11 is a partial enlarged perspective view of a coupling protrusion 243 of the case 241.

Referring to FIGS. 10 and 11, the coupling protrusion 243 is formed having a three-dimensional structure including a pair of side walls 431, an inclined wall 432, and a connecting wall 433.

The pair of side walls 431 is inclined and connected to the extension part 413 in both ends of the cutout line L by cutting one side and press-processing the cutout line L and the remaining three sides from the extension part 413. The side wall 431 is inclined with an angle of inclination e relative to the side wall 141 described above, that is, relative to a plane that is perpendicular to the extension part 413.

The inclined wall 432 is inclinedly connected to the pair of side walls 431 in the opposite side extension part 413 for the cutout line L. Therefore, the side wall 431 and the inclined wall 432 effectively lead the coupling protrusion 243 inserted into the insertion groove 24.

The connecting wall 433 connects between the side walls 431 and the inclined wall 432 and is disposed in parallel with the extension part 413. In addition, the end of the connecting wall 433 formed in the cutout line L and an end of the side wall 431 are formed to have an opened structure at an opposite side of the inclined wall 432 to couple with the coupling groove 26. Accordingly, the coupling protrusion 243 may maintain a joint force for the frame 20 in the height direction (e.g., the z-axis direction).

The side wall 431, the connecting wall 433, and the cutout line L, in one embodiment, are formed in a rectangle. When the case 241 is coupled to the frame 20, the coupling protrusion 243 is coupled with the coupling groove 26. In one embodiment, the connecting wall 433 has a width W1 narrower than the width W of the coupling groove 26, and the side walls 431 provided at both sides of the connecting wall 433 are spaced apart from inner side walls of the coupling groove 26. Therefore, when the case 241 is coupled to the frame 20, the coupling protrusion 243 may be easily coupled with the coupling groove 26.

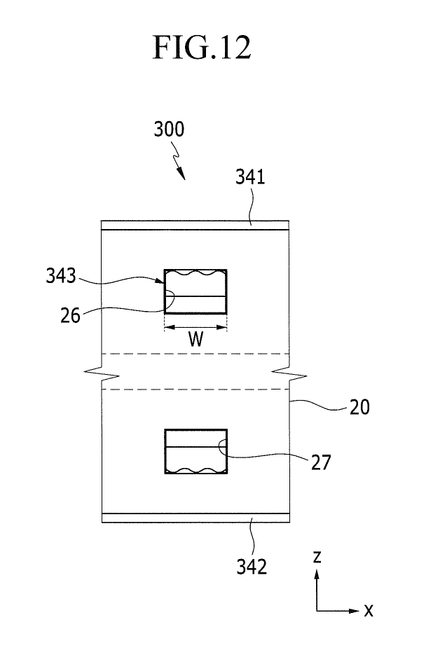

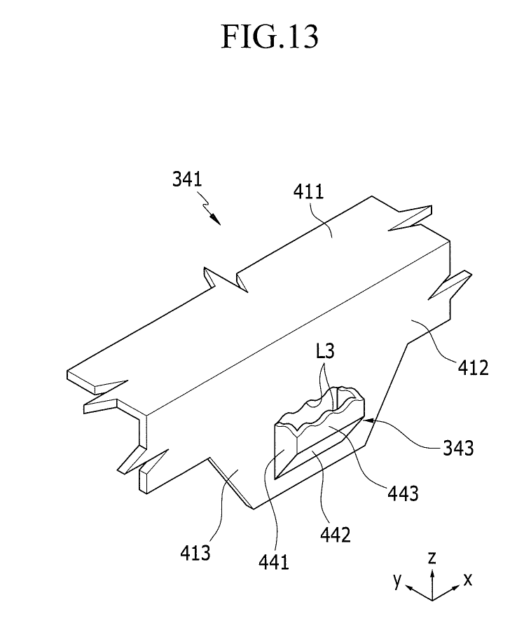

FIG. 12 is a partial side view showing a state in which a pair of cases 341 and 342 is coupled with the frame 20 of a rechargeable battery pack 300, according to another exemplary embodiment of the present invention; and FIG. 13 is a partial enlarged perspective view of a coupling protrusion 343 of the case 341.

The coupling protrusions 414, 424, and 243 according to the exemplary embodiments described above may have the cutout line L formed in a straight line, and the coupling protrusion 343 according to another exemplary embodiment of the present invention has a cutout line L3 formed in a protrusions and depressions structure.

Referring to FIGS. 12 and 13, the coupling protrusion 343 is formed in the three-dimensional structure including a pair of side walls 441, an inclined wall 442, and a connecting wall 443.

The pair of side walls 441 is inclinedly connected to the extension part 413 at both ends of the cutout line L3 by cutting one side in a protrusions and depressions structure and press-processing the cutout line L3 and the remaining three sides from the extension part 413.

The inclined wall 442 is inclinedly connected to the pair of side walls 441 in the opposite side extension part 413 for the cutout line L3. Therefore, the side wall 441 and the inclined wall 442 effectively lead the coupling protrusion 343 inserted into the insertion groove 24.

The connecting wall 443 connects between the side walls 441 and the inclined wall 442 and is disposed in parallel with the extension part 413. In addition, the end of the connecting wall 443 formed in the cutout line L3 and ends of the side walls 441 are formed to have an opened structure at an opposite side of the inclined wall 442 to couple with the coupling groove 26.

In one embodiment, the connecting wall 443 and the side wall 441 have the protrusions and depressions structure corresponding to the cutout line L3 forming the opening structure. In the state in which the coupling protrusion 343 of a metal material is coupled with the coupling groove 26 of the frame 20 of a synthetic resin material, the protrusions and depressions structure of the connecting wall 443 and the side wall 441 may be press-fitted into the coupling groove 26 of the frame 20. Therefore, the coupling protrusion 343 may maintain a strong joint force for the frame 20 in the height and length directions (e.g., the x- and z-axes directions).

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A rechargeable battery pack comprising:
a unit battery cell;
a frame surrounding perimeter sides of the unit battery cell;
a protective circuit module electrically connected to the unit battery cell and supported within the frame; and
a pair of case members coupled to the frame and covering respective first and second sides of the unit battery cell, the first and second sides being opposite each other,
wherein the frame comprises a circuit installation part at a side of the frame and supporting the protective circuit module.

2. The rechargeable battery pack of claim 1,
wherein the unit battery cell is a first unit battery cell, and the rechargeable battery pack further comprises a second unit battery cell, and
wherein the circuit installation part and the protective circuit module are between the first and second unit battery cells.

3. The rechargeable battery pack of claim 1,
wherein the unit battery cell comprises:
an electrode assembly comprising a positive electrode, a negative electrode, and a separator between the positive electrode and the negative electrode;
a pouch accommodating the electrode assembly; and
a positive electrode lead tab and a negative electrode lead tab electrically connected to the positive electrode and the negative electrode, respectively, and protruding outside the pouch in a same direction, and
wherein the circuit installation part comprises one or more first protrusions positioning at least one of the positive or negative electrode lead tabs.

4. The rechargeable battery pack of claim 3, wherein the circuit installation part has one or more first through-holes, and a case member of the pair of case members has one or more second through-holes corresponding to the one or more first through-holes, the one or more first through-holes and the one or more second through-holes exposing at least one of the positive or negative electrode lead tabs to an outside of the case member.

5. The rechargeable battery pack of claim 1, wherein the circuit installation part comprises at least one second protrusion supporting a side of the protective circuit module.

6. The rechargeable battery pack of claim 1,
wherein the protective circuit module comprises a connector, and the frame has an opening exposing the connector to an outside of the frame, and
wherein the circuit installation part comprises a third protrusion supporting the connector.

7. The rechargeable battery pack of claim 1, wherein the frame comprises a synthetic resin material, and the case members comprise a metal.

8. The rechargeable battery pack of claim 1, wherein a case member of the pair of case members comprises:
a plate part having a plate shape and covering a side of the first and second sides of the unit battery cell;
an insertion part bent from edges of the plate part; and
a plurality of coupling protrusions on the insertion part and coupled to the frame.

9. The rechargeable battery pack of claim 8, wherein the frame comprises an insertion groove receiving the insertion part.

10. The rechargeable battery pack of claim 9,
wherein the insertion groove is a first insertion groove at a first side of the frame, and receives the insertion part of the case member of the pair of case members, and
wherein the frame further comprises a second insertion groove at a second side of the frame opposite the first side and separated from the first insertion groove by a partitioning portion, the second insertion groove receiving an insertion part of the other case member of the pair of case members.

11. The rechargeable battery pack of claim 8, wherein the frame comprises a plurality of coupling openings receiving the coupling protrusions to couple the case member to the frame.

12. The rechargeable battery pack of claim 11, wherein the coupling openings are arranged along a perimeter of the frame.

13. The rechargeable battery pack of claim 8, wherein the insertion part comprises a plurality of extension parts extending in a direction away from the plate part, and the coupling protrusions are on the extension parts.

14. The rechargeable battery pack of claim 13, wherein extension parts of the plurality of extension parts extend from an edge of the insertion part and have widths that decrease in the direction away from the plate part.

15. The rechargeable battery pack of claim 8, wherein a coupling protrusion of the plurality of coupling protrusions has a three-dimensional structure including a pair of side walls, an inclined wall extending between the side walls, and a connecting wall connecting the side walls and the inclined wall.

16. The rechargeable battery pack of claim 15, wherein the connecting wall is offset from the insertion part, and the inclined wall is inclined away from the insertion part in a direction toward the plate part.

17. The rechargeable battery pack of claim 15, wherein the frame has a coupling opening receiving the coupling protrusion, and the connecting wall and the coupling opening have a same width.

18. The rechargeable battery pack of claim 15, wherein the frame has a coupling opening receiving the coupling protrusion, and the side walls are inclined at an angle such that a width of the connecting wall is less than a width of the coupling opening.

19. The rechargeable battery pack of claim 15, wherein the side walls and the connecting wall are separated from the insertion part along a straight cutout line.

20. The rechargeable battery pack of claim 15, wherein the side walls and the connecting wall are separated from the insertion part along a cutout line having protrusions and depressions.
